(19) United States
(12) Patent Application Publication
(10) Pub. No.: US 2025/0214193 A1
(43) Pub. Date: Jul. 3, 2025

(54) APPARATUS AND METHOD FOR WORKING SHEETS

(71) Applicant: FOREL S.P.A., Roncade (IT)

(72) Inventors: Fortunato VIANELLO, Roncade (IT); Riccardo VIANELLO, Roncade (IT); Dino MOSCHINI, Roncade (IT)

(21) Appl. No.: 18/851,789

(22) PCT Filed: Mar. 28, 2023
(86) PCT No.: PCT/IT2023/050092

§ 371 Date: Sep. 27, 2024

(30) Foreign Application Priority Data
Mar. 29, 2022 (IT) 102022000006089

(51) Int. Cl. B24B 9/10; B23Q 1/76; B24B 27/00

(52) U.S. Cl. CPC B24B 9/102; B23Q 1/766; B24B 27/003; B23Q 2240/002

(57) ABSTRACT

Apparatus for working a sheet comprising movement means configured to move at least one sheet at a time in a direction of advance, and at least one working unit comprising a working head on which there are installed at least one working tool and a stabilizer device having opposite first gripping members and second gripping members facing each other, and reciprocally mobile along an axis of grip and release to tighten said sheet between them and to release it.

### FIELD OF THE INVENTION

The present invention concerns an apparatus for working sheets, made of glass or other glass substitute materials, for the construction sector, both residential and commercial.

The invention can be applied, for example, but not only, in the production of glass sheets for; insulating glass, glazed walls and balustrades; for the furniture sector, for example furniture parts, shower cubicles and others; for the transport sector, for example windows or fronts for cars, buses, trucks and trains; and for the naval sector, for example railings.

The invention also relates to the relevant working method.

### BACKGROUND OF THE INVENTION

Apparatuses are known for working pre-cut glass sheets in various shapes—workings, rectangular, triangular, trapezoidal, etc.—and subsequently undergo further usually with the removal of material, to produce a finished or semi-finished product.

An example of such an apparatus for working sheets is described in document EP 3 170 622 A1.

Known apparatuses normally comprise one or more sheet movement units in a direction of advance and at least one fixed working unit having an angularly orientable working head mobile along a working direction. The working head has one or more working tools configured to perform perimeter grinding, drilling, milling or other works with typically material removal.

The working head is associated with a stabilizer device configured to temporarily couple to the perimeter edge of the glass sheet near the working tool in order to stabilize the position of the sheet and avoid vibrations that would risk. nullifying the works, rendering the finished or semi-finished product obtained unusable.

Such a stabilizer device usually comprises a pair of jaws on which idle rollers or other holding elements are mounted. The jaws are arranged in such a way that the rollers “sandwich” the sheet in correspondence with its perimeter edge.

At least one of the jaws has an opening-closing movement with respect to the other to allow holding the sheet and, since they are mounted on the working head, they are angularly orientable together with it to follow the profile of the sheet in correspondence with the corners of the sheet during working.

Such a solution works well for glass sheet shapes close to the rectangular one. In fact, if a sheet has a shape that is different from the rectangular one and/or has sharp vertices or having a rounded shape, the rollers of the stabilizer device cannot correctly hold the sheet because they lose contact with it departing from the contour thereof, and subsequently they must resume contact through a new insertion.

This implies, in correspondence with these vertices, a poor quality of the finished product in terms of: non-compliance with dimensional tolerances; mediocre or unacceptable surface finish; damages to any nanotechnological coating present on the surfaces of the sheet; sometimes the breakage of the sheet during working, especially in the case of reduced thicknesses.

There is therefore the need to perfect an apparatus and method for working sheets that can overcome at least one of the disadvantages of the state of the art.

To do this, it is necessary to solve the technical problem of effectively holding, during the working of the perimeter edge, also sheets having a shape other than rectangular, but not only, in particular near their vertices that are sharp or have rounded shapes.

Therefore, one purpose of the present invention is to realize an apparatus for working sheets, in particular made of glass, that allows to work in a precise, fast and reliable way sheets of any shape.

A further purpose of the present invention is to realize an apparatus for working sheets in which holding the sheet is optimized, as well as in relation to the shape of the sheet itself, also in relation to the wear of the working tool.

Another purpose of the present invention is to develop a method capable of working in a fast, stable and reliable way sheets of any shape offering a high quality finished product.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problem disclosed above in a new and original way, also achieving considerable advantages compared to the state of the prior art, an apparatus according to the present invention for working sheets, in particular made of glass, comprises movement means configured to move at least one sheet at a time in a direction of advance, and at least one working unit comprising a working head, mobile along a working axis, on which there are installed at least one working tool and a stabilizer device having opposite first gripping members and second gripping members facing each other, and reciprocally mobile along an axis of grip and release to tighten said sheet between them and to release it, wherein said working head is selectively rotatable to angularly orient said gripping members.

By the term “reciprocally mobile” it is meant that at least one of the first and second gripping members is mobile with respect to the other of said gripping members to tighten the sheet between them and to release it.

In accordance with another aspect of the present invention, said first and second gripping members are configured to be selectively moved in an integral way at least along a first axis of adjustment distinct from said axis of grip and release in order to be disposed in a position, or condition, of complete grip with said sheet.

In accordance with another aspect of the present invention, said working head can be selectively moved along its own working axis. Said first axis of adjustment is distinct and independent with respect to said working axis.

In accordance with another aspect of the present invention, said first axis of adjustment is orthogonal to said axis of grip and release.

In accordance with another aspect of the present invention, said first and second gripping members are configured to be selectively moved in an integral way, also along a second axis of adjustment distinct from said axis of grip and release and from said first axis of adjustment.

In accordance with another aspect of the present invention, said second axis of adjustment is orthogonal to said axis of grip and release and to said first axis of adjustment.

In accordance with another aspect of the present invention, said first and second axes of adjustment form, together with said axis of grip and release, a set of three coordinated axes orthogonal to each other.

In accordance with another aspect of the present invention, said stabilizer device comprises a first adjustment actuator and a distinct second adjustment actuator which are respectively configured to move said first and second gripping members along said first axis of adjustment and along said second axis of adjustment.

In accordance with another aspect of the present invention, said apparatus comprises a central control unit configured to control in a combined way said movement means, said working head and said stabilizer device, both in order to control the correct positioning of said first and second gripping members with respect to a perimeter edge of said sheet, depending on the shape of the latter, and with respect to said working tool, depending on the state of wear of the tool.

In accordance with another aspect of the present invention, said first and second gripping members comprise at least one respective support element and at least one respective contact element in the shape of a wheel attached in a rotatably idle way to its support element, wherein said contact elements have an external coating made of elastic deformable material.

According to a variant, the contact elements may be defined by, or comprise, hydrodynamically supported wheels or skids, balls on ball cradles, tracked rolling elements or other similar or assimilable elements.

The present invention also concerns a method for working sheets comprising:
a movement step, in which said sheet is made to advance in said direction of advance by means of movement means toward said working head;

-a step of identifying said perimeter edge aimed at correctly positioning said sheet with respect to said working tool mounted on said working head;
an initial adjustment step, in which said first and second gripping members mounted on said working head, which are initially in a reciprocally distanced condition, are subsequently taken into a gripping condition with said sheet, with a movement along an axis of grip and release of at least one of said gripping members with respect to the other;
a working step, in which said working tool works said perimeter edge;
an orientation step, in which said working head is made to rotate according to an angle of orientation in order to angularly orient said first and second gripping members with respect to said perimeter edge, at least in the case in which said working tool has to remove material in correspondence with or in the vicinity of a vertex of said perimeter edge.

According to an aspect of the present invention, said method provides a further adjustment step, in which said first and second gripping members are selectively moved in an integral way at least along a first axis of adjustment distinct from said axis of grip and release toward a position in which they are in a condition of complete grip on said sheet.

In accordance with another aspect of the present invention, during said further adjustment step said first and second gripping members are selectively moved in an integral way also along a second axis of adjustment distinct from said axis of grip and release and from said first axis of adjustment.

The movement of the gripping members along the two directions of adjustment, combined where necessary with their angular orientation, allows to keep the gripping members always gripped on the sheet, at an optimal distance from the perimeter edge of the sheet and from the tool.

In accordance with another aspect of the present invention, the adjustment of the position of said first and second gripping members along said first and second axes of adjustment occurs “on the fly”, with the sheet always gripped between them.

In accordance with another aspect of the present invention, the position of said first and second gripping members is adjusted in feedback by means of a central control unit both on the basis of the position of said working tool with respect to the perimeter edge of said sheet, and also on the basis of the wear of said working tool.

### DESCRIPTION OF THE DRAWINGS

These and other aspects, characteristics and advantages of the present invention will become apparent from the following description of an embodiment, given as a non-restrictive example with reference to the attached drawings wherein:

FIG. 1 is a schematic view of an apparatus for working sheets according to the present invention;

FIG. 2 is a perspective view of the working unit seen from the side of the working plan;

FIG. 3 is a perspective view of the working head visible in FIG. 2;

FIGS. 4-6 illustrate the stabilizer device in top, side and front view, respectively;

FIGS. 7a-7c schematically illustrate the working of a vertex of a sheet having a triangular shape;

FIG. 8 shows a functional diagram of the control system for managing the apparatus of FIG. 1.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF AN EMBODIMENT OF THE PRESENT INVENTION

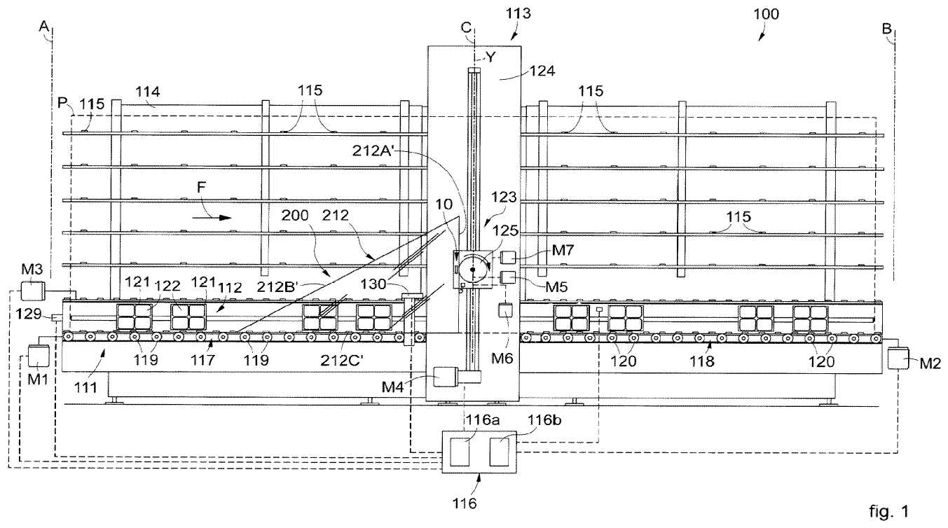

With reference to FIG. 1, an apparatus 100 according to the present invention is shown, configured to perform grinding operations on sheets 200 for example, but not exclusively, made of glass. The same apparatus 100, if differently equipped, can also perform drilling, milling or other working operations in the mechanical glass working sector.

More generally, such sheets 200 may be made of a brittle material having a glass-like behaviour.

Each sheet 200 has a first lateral, or front, surface 210, an opposite second lateral, or rear, surface 211, and a perimeter edge 212 having a thickness T.

The lateral surfaces 210, 211 are essentially flat and may have a rectangular, circular, elliptical, curvilinear, trapezoidal, polygonal triangular shape or a combination thereof.

In the case of a triangular sheet, the perimeter edge 212 may be defined by a front side 212A′, an opposite rear side 212B′, and a lower side 212C′.

Each sheet 200 may furthermore be monolithic, i.e. made with a single monolithic glass panel, or laminated if it comprises two monolithic glass panels between which a membrane is arranged, for example made of plastic material. In this case, a monolithic sheet 200 may have a thickness T between about 3 mm and about 20 mm; a laminated sheet 200 may have an overall thickness T between about 6 mm and about 30 mm.

The lateral surfaces 210, 211 of the sheets 200 may further have a nanotechnological coating conferring the capability of reflecting either infrared rays, to improve winter thermal insulation, or solar radiations, to improve summer thermal insulation.

According to embodiments, the apparatus 100 comprises an inlet section A in correspondence of which one or more sheets 200 to be worked are provided to the apparatus 100 manually, or in an automated manner by further apparatuses arranged upstream, and an outlet section B in correspondence of which the worked sheets 200 are evacuated from the apparatus 100 toward further apparatuses arranged downstream.

The apparatus 100 comprises a working plane P on which the sheets 200 rest with respect to one of the two lateral surfaces 210, 211. The orientation of the sheet 200 on the working plane P may depend on the type of sheet 200, on the presence or absence of surface coatings or other. Typically, the sheet 200 rests on the working plane P with its rear lateral surface 211.

The working plane P is defined by a support wall 114 consisting of a plurality of lines of idle wheels 115 extending from the inlet section A to the outlet section B and against which the sheet 200 is rested, for example with respect to its rear lateral surface 211.

Said working plane P is substantially vertical, in particular slightly inclined by some degree, for example by about 6°, with respect to a generic vertical plane. According to a variant embodiment, the working plane P can be horizontal or have any inclination with respect to a support plane.

The apparatus 100 comprises a first movement unit 111 configured to move on the working plane P one or more of the aforesaid sheets 200 in a direction of advance F supporting it and dragging it below, i.e. with respect to the lower side 212C′ of the perimeter edge 212. In FIG. 1, the direction of advance F runs from the inlet section A to the outlet section B.

According to embodiments, the first movement unit 111 comprises an inlet conveyor 117, extending from the inlet section A to an intermediate section C, positioned between the inlet section A and the outlet section B, and an outlet conveyor 118, extending from the intermediate section C to the outlet section B.

Each conveyor 117, 118 is provided with a plurality of rollers 119, 120 driven by a respective first motor M1 and a second motor M2. The rollers 119, 120 define at the top a support plane for the sheet 200 that rests on them with the lower side 212C′. As an alternative to the rollers 119, 120, the conveyors 117, 118 may comprise belts, tapes, mats or similar or assimilable movement devices.

The apparatus 100 further comprises a second movement unit 112, which together with the first movement unit 111 forms generic movement means, configured to move the sheet 200 on the working plane P in the direction of advance F dragging it laterally, i.e. with respect to its first lateral surface 210, i.e. the front one, or more advantageously with respect to its second lateral surface 211, i.e. the rear one.

The second movement unit 112 extends continuously from the inlet section A to the outlet section B and comprises one or more carriages 121 driven by means of a third motor M3 and sliding on lateral guides 126.

Each carriage 121 is provided with suction cups 122 which are connected to a pneumatic circuit controlled in depression for holding, and in pressure for releasing, the sheet 200. The suction cups 122 are configured to hold the sheet 200 with respect to a lateral surface 210, 211 thereof, advantageously with respect to the rear lateral surface 211.

The first and second movement units 111, 112 can be activated simultaneously to cooperate in the movement of the same sheet 200 or can be activated independently.

According to embodiments, the movement of the sheet 200 can occur in a coordinated and simultaneous way both through the first movement unit 111 and through the second movement unit 112, or it can occur independently with one or the other of said movement units 111, 112. For example, the first movement unit 111 can be used in the steps of transferring the sheet 200 from the inlet section A to the outlet section B, while the second movement unit 112 can be used to cause the sheet 200 to advance during working.

The apparatus 100 further comprises at least one working unit 113 arranged in correspondence with the intermediate section C positioned between the inlet section A and the outlet section B.

The working unit 113 has a vertical or inclined configuration, substantially parallel to the working plane P.

The working unit 113 comprises a working head 123 and a guide 124 which develops along a working axis Y and along which the working head 123 is slidable.

The guide 124 terminates below the support plane defined by the rollers 119, 120 so as to allow the working head 123 to also reach the lower side 212C′ of the perimeter edge 212 of the sheet 200.

The movement of the working head 123 along the working axis Y is managed by a fourth motor M4.

The working unit 113 comprises a working tool 125 associated with the working head 123. The working tool 125 is keyed on a spindle associated with the working head 123, in a manner known per se, and its rotation is managed by a fifth motor MS. The fifth motor M5 may possibly be adjusted by an inverter to vary the speed of rotation of the working tool 125 as required.

In addition to being able to rotate, the working tool 125 is mobile with respect to the working head 123 along an axis of regulation Z transverse to the working axis Y and orthogonal to the working plane P. The axis of regulation Z coincides with the axis of rotation of the working tool 125. The regulation movement of the working tool 125 can be configured with a translation of the spindle on which the working tool 125 is keyed along the axis of rotation of the latter.

The regulation movement of the working tool 125, which can occur both “on the fly” and before the start of working, is managed by a sixth motor M6.

In the embodiment described herein, the working tool 125 is a grinding wheel which may comprise a number of abrasive discs keyed on the same shaft. Such abrasive discs can be different either by thickness range, or by constituent characteristics and are suitable for the surface finish and the profile to be obtained on the perimeter edge 212 of the sheet 200.

The movement of the working tool 125 along the axis of regulation Z serves both to operate along the entire thickness T of the sheet 200 and to alternate different sections of the working tool 125, i.e. the aforementioned abrasive discs.

The working unit 113 further comprises a stabilizer device 10 associated with the working head 123 and configured to hold the sheet 200 in correspondence with its perimeter edge 212, in proximity to the working tool 125. The stabilizer device 10 is, in particular, configured to stabilize the position of the sheet 200 and prevent vibrations during working by the working tool 125.

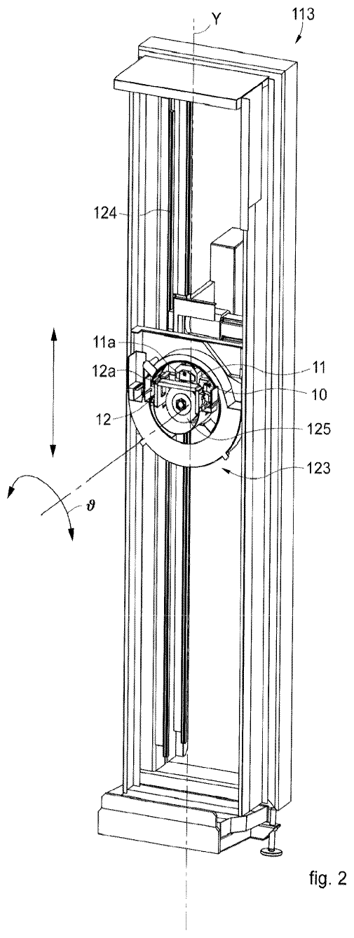

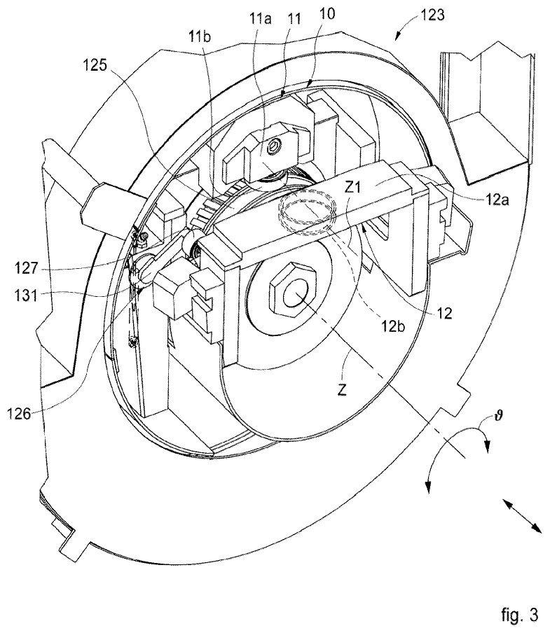

With reference to FIGS. 2-3, the stabilizer device 10 comprises opposite first gripping members 11 and second gripping members 12 facing each other, configured to “sandwich” the sheet 200 at least during the working operated by the working tool 125 to avoid vibrations.

The first and second gripping members 11, 12 are, in use, on one side and the other of the sheet 200, respectively. In particular, during working the first gripping members 11 face in contact with the front surface 210 of the sheet 200 while the second gripping members 12 face in contact with the rear surface 211 of the sheet 200, which rear surface 211 lies on the working plane P.

At least the first gripping members 11 can be selectively moved along an axis of grip and release Z1 toward/away from the second gripping members 12 to tighten the sheet 200 between them or to release it at the end of working. In other words, the first gripping members 11 are configured to translate along the axis of grip and release Z1 with the aim of adapting their position with respect to the second gripping members 12 as a function of the thickness T of the sheet 200.

The gripping members 11, 12 are aligned along the axis of grip and release Z1 and between them there is an interspace that assumes a calibrated value functional to the holding of the glass sheet 200, however that allows an adequate sliding freedom thereof.

The axis of grip and release Z1 is orthogonal to the front surface 210 of the sheet 200. In addition, the axis of grip and release Z1 is parallel to the axis of regulation Z and to the axis of rotation of the working tool 125.

In contrast, the second gripping members 12 are attached with respect to a movement along the axis of grip and release Z1. However, solutions in which both gripping members 11, 12 are mobile or solutions in which only the second gripping members 12 are mobile are not excluded.

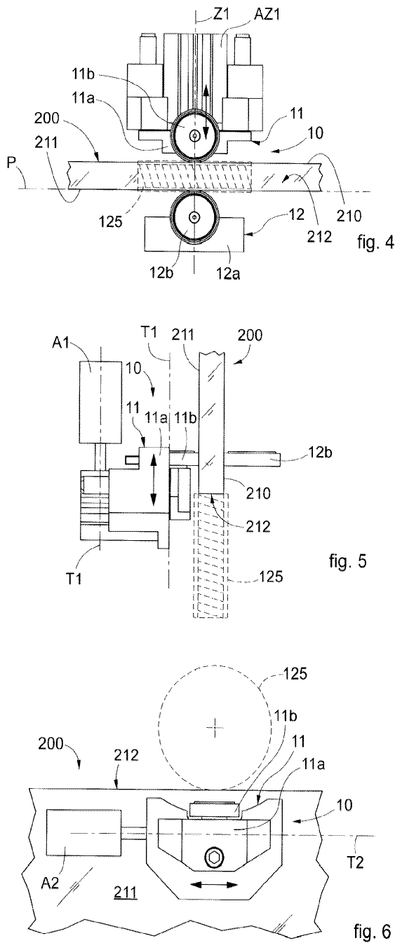

The stabilizer device 10 therefore comprises a gripping actuator AZ1 operatively connected to first gripping members 11 to cause their movement as described above, FIG. 4. Being the position of the rear surface 211 and the thickness T of the sheet 200 known, it is possible to command the gripping actuator AZ1 so that the first gripping members 11 contact the front lateral surface 210 of the sheet 200 with the desired pressure,

The movement of the first gripping members 11 is independent of the regulation movement of the working tool 125. Therefore, the gripping actuator AZ1 is distinct and independent from the sixth motor M6 which cause the regulation movement of the working tool 125 along the axis of regulation Z.

The first and second gripping members 11, 12 are selectively orientable in rotation according to an angle of orientation θ about an axis of orientation coinciding with the axis of regulation Z and with the axis of rotation of the working tool 125. This orientation according to the angle of orientation θ is operated by a seventh motor M7.

Operatively, it is the working head 123 that is orientable according to the angle of orientation 0 while the first and second gripping members 11, 12 and the working tool 125, which are integral with the working head 123, undergo its movement. Therefore, the first and second gripping members 11, 12 always rotate in an integral way with each other, i.e. rigidly, at the same angle of orientation θ.

The working head 123 bas thus two degrees of freedom: a translation along the working axis Y and a rotation according to the angle of orientation θ around the axis of orientation.

The rotation of the angle of orientation θ is however only functional to correctly orient the first and second gripping members 11, 12 with respect to the sheet 200. In fact, since the working tool 125, at least in the case of the grinding wheel, has a cylindrical conformation, its angular orientation around its axis of rotation would still not entail any effective variation in its functionality.

The first and second gripping members 11, 12 can be therefore moved, with respect to the working head 123 that supports them, according to the angle of orientation θ as described above.

The first and second gripping members 11, 12 can be selectively moved at least along a first axis of adjustment T1 orthogonal to the axis of grip and release Z1, FIG. 5. The first axis of adjustment T1 is a radial axis with respect to the centre of the working tool 125.

The first and second gripping members 11, 12 can be selectively moved also along a second axis of adjustment T2 orthogonal to the axis of grip and release Z1 and to the first axis of adjustment TI, FIG. 6. The second axis of adjustment T2 is a tangential axis with respect to the peripheral surface of the working tool 125.

The stabilizer device 10 thus comprises a first adjustment actuator A1 and a distinct second adjustment actuator A2 which are respectively configured to move the first and second gripping members 11, 12 along the first axis of adjustment T1 and along the second axis of adjustment T2.

The position of the first and second gripping members 11, 12 along the first and second axes of adjustment T1, T2 is fed back, for example by means of a potentiometer.

The first and second axes of adjustment T1, T2 are made by means of guide elements attached to, or cooperating with, the working head 123, for example an endless screw. It is evident that the stroke of the first and second gripping members 11, 12 along the first and second axes of adjustment T1, T2 is constrained to the length of the guide element on which they are slidable or with which they are associated.

The first and second axes of adjustment T1, T2 together with the axis of grip and release Z1 form a set of three coordinated axes orthogonal to each other.

The movement of the first and second gripping members 11, 12 both along the first T1 and along the second T2 axis of adjustment occurs in a coordinated and integral way so that, in each position, they maintain the same opposite arrangement facing each other.

Overall, the first and second gripping members 11, 12 can be moved according to three degrees of freedom: a rotation of the angle of orientation θ, a translation along the first axis of adjustment T1, and a translation along the second axis of adjustment T2. The first gripping members 11 have, as mentioned, a further degree of freedom of translation along the axis of grip and release Z1.

The mobility of the first and second gripping members 11, 12 according to the three degrees of freedom allows their correct positioning with respect to the perimeter edge 212 of the sheet 200 preventing the latter from protruding from the profile thereof causing a reduction in stability during working.

In fact, the rotation only of the first and second gripping members 11, 12 of the angle of orientation θ, as occurs in the prior art, is not sufficient to guarantee a stable grip of the sheet 200 in any situation that may arise.

Especially in the case where the sheet 200 has a shape with sharp vertices between one side and the next of its perimeter edge 212 and the working must take place near the vertex, the possibility of rotating and appropriately positioning the first and second gripping members 11, 12 becomes crucial to keep the grip on the sheet 200 firm and avoid vibrations during working.

In fact, in the case of working an acute vertex, the first and second gripping members 11, 12 can be moved, favourably in an interpolated way, along the first and second axes of adjustment T1, T2 toward a position in which they are in a complete gripping condition on the sheet 200. The complete gripping condition is configured when the contact area of the gripping members 11, 12 on the sheet 200 is maximum.

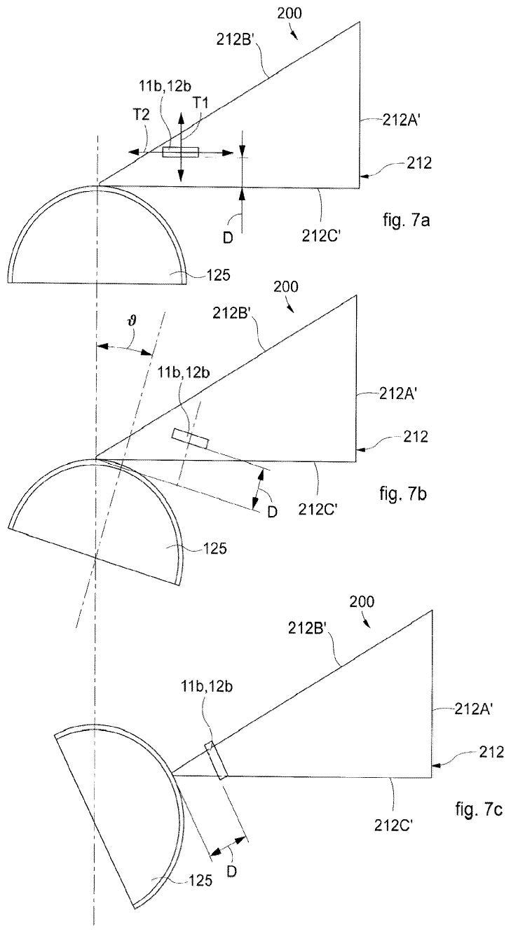

As exemplarily represented in FIGS. 7a-7c, during the working of the lower side 212C′ of the sheet 200, which in this case has a triangular shape, the first and second gripping members 11, 12 are parallel to the lower side 212C′. As the working tool 125 approaches the sharp vertex of the sheet 200, the gripping members 11, 12 are made to rotate by the angle of orientation θ, by rotation of the working head 123, and favourably moved along one or both of the axes of adjustment T1, T2. During their movement, a certain distance D from the peripheral surface of the working tool 125 is maintained. This distance D can be favourably constant.

The first and second gripping members 11, 12 comprise a respective support element 11a, 12a, which can be for example a jaw, and a respective contact element 11b, 12b, which can be a wheel or an idle roller, associated with the corresponding support element 11a, 12a. Obviously, each of the support elements 11a, 12a may also comprise multiple contact elements 11b, 12b,

Alternatively, the contact elements 11b, 12b may be defined or comprise hydrodynamically supported wheels or skids, ball on ball cradles, tracked rolling elements or other similar or assimilable elements.

In the example described herein, the contact elements 11b, 12b are idle wheels having axis of rotation orthogonal to the axis of rotation of the working tool 125.

During the working of one side of the perimeter edge 212 of the sheet 200 the faces of the wheels remain parallel to said side and their radial location on the lateral surfaces 210, 211 with respect to the axis of rotation of the working tool 125 is such as to maintain an overhang from the perimeter edge 212 of about 5-10 mm while the distance between the same wheels, in the transverse direction with respect to the lateral surfaces 210, 211, had been calibrated as a function of the thickness T of the sheet 200.

According to embodiments, the wheels have an external coating made of elastic deformable material so that when they press on the sheet 200, the contact area acting on the latter has an almost rectangular shape with sides having length equal to the distance between the faces of the wheel and width equal to about 1-2 mm.

The apparatus 100 comprises a central control unit 116 configured at least to manage the first movement unit 111 through the first and second motor M1, M2, the second movement unit 112 through the third motor M3, and the working unit 113 through the fourth motor M4 which working unit 113 comprises: the working head 123 with the working tool 125 and the stabilizer device 10, driven by the fifth, sixth and seventh motor M5, M6, M7, in order to ensure the execution of optimized working on the sheet 100. The central control unit 116 comprises a central working unit, or CPU, 116a and at least one memory unit 116b connected to it,

The central control unit 116 is configured to manage the movement of the first and second gripping members 11, 12 along the first axis of adjustment T1 and along the second axis of adjustment T2 to guarantee at all times the complete gripping condition on the sheet 200, in coordination with the rotation of the same gripping members 11, 12 according to the angle of orientation θ. Further, the movement of the first and second gripping members 11, 12 along the first axis of adjustment T1, which is radial with respect to the centre of the working tool 125, is managed by the central control unit 116 also on the basis of the wear of the working tool 125, The more the working tool 125 is worn, the more the first and second gripping members 11, 12 are brought radially closer to it so as to keep the overhang from the perimeter edge 212 constant or otherwise optimal with respect to the periphery of the working tool 125,

According to embodiments, the working head 123 also comprises a feeler device 130 configured to detect the geometry of the perimeter edge 212 of the sheet 200 so as to provide information to the control unit 116 for example, but not only so that the latter processes and sends signals to adjust the depth of passage of the working tool 125 or to reposition the first and second gripping members 11, 12, or to adjust the advance of the sheet 200 along the direction of advance F or of the working head 123 along the working axis Y.

The feeler device 126 is able to provide the central control unit 116 with information on the actual position of the perimeter edge 212 to correct the relative positioning between the working tool 125 and the perimeter edge 212 of the sheet 200, for example with respect to a corresponding input data from a management information system in which the geometric values of the sheets 200 to be worked are loaded.

The feeler device 126 is attached to the working head 123 and comprises an idle feeler wheel 127 and a tilting support arm 131 on one end of which the feeler wheel 127 is mounted which is configured to contact the surface of the perimeter edge 212 of the sheet 200 while the sheet 200 moves along the direction of advance F or while the working head 123 moves along the working axis Y.

When the surface of the perimeter edge 212 has irregularities or a change in inclination of the surface, the feeler wheel 127 detects them, tilts the support arm 131 which is connected to a transducer which can generate and send a suitable feedback signal to the control unit 116.

The apparatus 100 comprises, in correspondence with the inlet section A, a measuring device 129 configured to measure the thickness T of the sheet 200 and to send a corresponding measuring signal to the control unit 116 so that the data relating to the measured thickness T can be stored in the memory unit 116b and used for example, but not only, to adjust the stroke of the first gripping members 11 along the axis of grip and release Z1 and to adjust the movement of the working tool 125 on the fly in order to work the entire thickness T of the sheet 200.

The apparatus 100 comprises, immediately upstream of the intermediate section C, one or more proximity devices 130 configured to detect the arrival of the sheet 200 and to send a corresponding proximity signal to the control unit 116 which, in turn, generates a command signal and sends it to the motors M1-M3 to cause the slowing down or the interruption of the movement of the sheet 200.

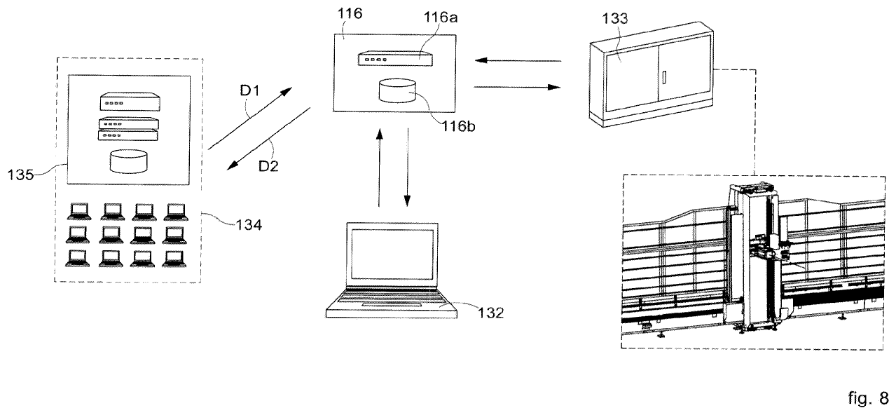

According to embodiments, illustrated in FIG. 8, the central control unit 116 is associated with an operator interface 132, for example via an Ethernet network. The operator interface 132 is part of the apparatus 100 and is configured to allow the control, supervision and management of the production process of the sheets 200 by an operator.

The central control unit 116 is configured to execute a specific work program that contains the scripts to manage in a coordinated way the movements (Z1, θ, T1, T2) of the stabilizer device 10, the movement of the working head 123 and the advance/backward motion of the sheet 200 along the working direction F. To this end, the central control unit 116 is connected to the electrical panel 133 that powers the motors M1-M7 and the actuators AZ1, A1, A2.

The central control unit 116 is also operatively connected to a company information system 134 provided with its own local control unit 135 configured to execute a management program capable of providing input data D1 to the central control unit 116 according to the production program to be executed.

The input data D1, for each sheet 200, may for example comprise:
dimensions and shape of the sheet 200;
type of sheet 200 (monolithic or laminated glass);
indication of the lateral surface 210, 211 on which any surface coatings are present, both to correctly orient the sheet 200 on the working plane P, and to orient the gripping members 11, 12 in an optimal way to avoid damage to the coating;
type of profile of the perimeter edge 212 to be obtained, for example flat, trapezoidal, radiused, profiled, etc.;
degree of finish required, for example rough, semi-rough, polished, etc.;
depth of the passage suitable to eliminate the irregularities of the perimeter edge 212 and obtain the desired dimensional geometry;
composition of the working tool 125;
destination of the sheet 200, for example further working line or carriage and position in the carriage.

In turn, the central control unit 116 is capable of providing output data D2 to the company information system 134. The output data D2, for each sheet 200, may comprise for example:
working start time for each sheet 200;
working end time for each sheet 200;
energy used;
working parameters;
discarded pieces;
wear of the working tool 125;
interruptions in working;
identification of the operator who supervised the process;
parameters relating to refrigeration/lubrication fluids used during working.

Thanks to the work program and the management program, for each singular situation (sharp, obtuse vertices of the sheet, presence of coating, etc.) the ideal positioning conditions of the gripping members 11, 12 are identified. These ideal conditions are first processed and then made available in a database to which the central control unit 116 connects to receive in input the interpolating functions of the motion of the sheet 200 along the direction of advance F, of the motion of translation of the working head 123, of the movements (Z1, θ, T1, T2) of the stabilizer device 10 and of the movement of regulation of the working tool 125.

The operation of the apparatus 100, which corresponds to the method according to the present invention, comprises the following steps:
a movement step, in which a sheet 200 is made to advance in the direction of advance F by means of the movement units 111, 112 toward the working head 123;
a step of identifying the perimeter edge 212 aimed at correctly positioning the sheet 200 with respect to the working tool 125;
a step of adjusting the gripping members 11, 12 which are initially in a distanced condition and are subsequently taken into a gripping condition with the sheet 200 at the moment in which the glass sheet is moved in correspondence of the working tool 125.

In the gripping condition, the pressure exerted by the gripping members 11, 12 is a compromise between deformability of the external coating in elastic material of the contact elements 11b, 12b, ability to support the load by the sheet 200, freedom of reciprocally sliding between contact elements 11b, 12b and sheet 200, need to preserve the possible coating of the sheet 200 intact.

The method provides a subsequent working step of the perimeter edge 212 of the sheet 200 operated by the working tool 125. During the working step, the sheet 200 or the working head 123, or both, are moved in a coordinated way for the execution of the working on the entire perimeter edge 212 or on at least a part of it.

During the working step when the working tool 125 has to remove material in correspondence with or near a vertex of the perimeter edge 212, the method provides a further step of adjusting the gripping members 11, 12.

The further step of adjusting the gripping members 11, 12 comprises at least one of: a rotation of the gripping members 11, 12 about the axis of orientation according to the angle of orientation θ, a translation of the gripping members 11, 12 along the first axis of adjustment T1, a translation of the gripping members 11, 12 along the second axis of adjustment T2.

The additional adjustment step can occur simultaneously with the working step. Furthermore, the adjustment of the position of the first and second gripping members 11, 12 along the first and second axes of adjustment T1, T2 occurs “on the fly” with the sheet 200 always gripped between them.

It is clear that modifications and/or additions of parts may be made to the apparatus 100 and to the method for working sheets 200 as described heretofore, without departing from the field and scope of the present invention, as defined by the claims.

It is also clear that, although the present invention has been described with reference to some specific examples, a person of skill in the art shall certainly be able to achieve other equivalent forms of an apparatus and method for working sheets, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. Apparatus for working sheets comprising:
movement means configured to move at least one sheet at a time in a direction of advance,
at least one working unit comprising a working head on which there are installed at least one working tool and a stabilizer device having opposite first gripping members and second gripping members facing each other, and reciprocally mobile along an axis of grip and release to tighten said sheet between them and to release it, wherein said working head is selectively rotatable according to an angle of orientation to angularly orient said gripping members and
wherein, said first and second gripping members are configured to be selectively moved in an integral way at least along a first axis of adjustment distinct from said axis of grip and release in order to be disposed in a position of complete grip with said sheet.

2. Apparatus as in claim 1, wherein said first and second gripping members are configured to be selectively moved in an integral way also along a second axis of adjustment distinct from said axis of grip and release and from said first axis of adjustment.

3. Apparatus as in claim 2, wherein said first and second axes of adjustment form, together with said axis of grip and release, a set of three coordinated axes orthogonal to each other.

4. Apparatus as in claim 2, wherein said stabilizer device comprises a first adjustment actuator and a distinct second adjustment actuator, which are respectively configured to move said first and second gripping members along said first axis of adjustment and along said second axis of adjustment.

5. Apparatus as in claim 1, wherein it comprises a central control unit configured to control in a combined way said movement means, said working head and said stabilizer device, in order to control the correct positioning of said first and second gripping members both with respect to a perimeter edge of said sheet and also with respect to said working tool.

6. Apparatus as in claim 1, wherein said first and second gripping members comprise at least one respective support element and at least one respective contact element in the shape of a wheel attached in a rotatably idle way to its support element, wherein said contact elements have an external coating made of elastic deformable material.

7. Method for working sheets comprising:
a movement step, in which a sheet is made to advance in a direction of advance by means of movement means toward a working head, a step of identifying said perimeter edge, aimed at correctly positioning said sheet with respect to a working tool mounted on said working head,
an initial adjustment step, in which first and second gripping members mounted on said working head, which are initially in a reciprocally distanced condition, are subsequently taken into a gripping condition with said sheet with a movement along an axis of grip and release of at least one of said first and second gripping members with respect to the other,
a working step, in which said working tool works the perimeter edge, an orientation step, in which said working head is made to rotate according to an angle of orientation in order to angularly orient said first and second gripping members with respect to said perimeter edge, at least in the case in which said working tool has to remove material in correspondence with or in the vicinity of a vertex of said perimeter edge, and
wherein said method provides another adjustment step, in which said first and second gripping members are selectively moved in an integral way at least along a first axis of adjustment distinct from said axis of grip and release toward a position in which they are in a condition of complete grip on said sheet.

8. Method as in claim 7, wherein during said other adjustment step, said first and second gripping members are selectively moved in an integral way also along a second axis of adjustment distinct from said axis of grip and release and from said first axis of adjustment, wherein said first and second axes of adjustment form, together with said axis of grip and release, a set of three coordinated axes orthogonal to each other.

9. Method as in claim 8, wherein the adjustment of the position of said first and second gripping members along said first and second axes of adjustment occurs “on the fly” with the sheet always gripped between them.

10. Method as in claim 7, wherein the position of said first and second gripping members is adjusted in feedback by means of a central control unit, both on the basis of the position of said working tool with respect to the perimeter edge of said sheet, and also on the basis of the wear of said working tool.
